(19) United States
(12) Patent Application Publication
(10) Pub. No.: US 2026/0333174 A1
(43) Pub. Date: Oct. 22, 2026

(54) PRIVACY-PRESERVING HANDOVER PREDICTIONS USING ANONYMOUS MOBILITY QUERIES

(71) Applicant: Cisco Technology, Inc., San Jose, CA (US)

(72) Inventors: Srinath Gundavelli, San Jose, CA (US); Matthew S MacPherson, Apex, NC (US); Malcolm Muir Smith, Richardson, TX (US)

(21) Appl. No.: 19/416,827

(22) Filed: Dec. 11, 2025

Related U.S. Application Data
(60) Provisional application No. 63/791,131, filed on Apr. 18, 2025.

(51) Int. Cl. H04W 36/32; H04W 36/00; H04W 36/30; H04W 12/04

(52) U.S. Cl. CPC H04W 36/32; H04W 36/0038; H04W 36/302; H04W 12/04

(57) ABSTRACT

Techniques for privacy-preserving handover predictions in wireless communication networks using anonymous mobility queries. A mobile device generates a random, one-time-use MAC address for handover prediction requests, distinct from the device's physical or session MAC address. The device transmits a handover prediction request using the random MAC address, including motion data comprising location information, speed, direction, or trajectory. A network device receives the request and processes the motion data using venue layout information, access point locations, and historical mobility patterns to generate a handover prediction without identifying the mobile device. The network device transmits a handover prediction response containing handover guidance, such as timing, target access point identification, or access technology recommendations, while maintaining anonymity through the random MAC address.

### CROSS-REFERENCE TO RELATED APPLICATIONS

This application claims priority to U.S. Provisional Patent Application No. 63/791,131, filed Apr. 18, 2025, the entire contents of which are incorporated herein by reference.

### TECHNICAL FIELD

The present disclosure relates to privacy-preserving network-assisted handover predictions in wireless communication networks using anonymous mobility queries to enable proactive handover decisions while maintaining client device anonymity.

### BACKGROUND

Wireless communication networks enable mobile devices to maintain connectivity as users move between different coverage areas by performing handovers between access points or between different access technologies such as Wi-Fi and cellular networks. These handover mechanisms allow devices to seamlessly transition from one network connection to another while preserving ongoing communication sessions and maintaining quality of service for applications. Modern wireless networks typically employ reactive handover approaches where mobile devices monitor signal strength and other radio frequency parameters to determine when to initiate a handover to a different access point or network technology.

Current handover implementations face several challenges that can degrade user experience and network performance. Mobile devices often exhibit “sticky” behavior, remaining connected to their current access point even when signal quality deteriorates or when superior alternatives become available. This reactive approach introduces substantial latency during handover events, as devices must first detect poor signal conditions, scan for alternative networks, and then establish new connections. The delays associated with these reactive handover processes can result in service interruptions lasting many seconds, during which applications may become unresponsive or lose connectivity entirely.

While network operators possess valuable information about venue layouts, access point locations, radio frequency characteristics, and historical mobility patterns that could enable more intelligent handover decisions, mobile device vendors are reluctant to share detailed location and movement data due to privacy concerns. This creates a fundamental tension between the desire for network-assisted handover optimization and the protection of user privacy. Existing approaches to address handover latency through static signal thresholds or basic heuristics fail to account for environmental variations and venue-specific characteristics, limiting their effectiveness across diverse deployment scenarios. Consequently, there remains a need for handover mechanisms that can leverage network intelligence while preserving user privacy and enabling proactive handover decisions.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture diagram for privacy-preserving handover predictions using anonymous mobility queries in wireless communication networks, showing the interaction between client devices and network infrastructure during handover prediction operations.

FIG. 2 illustrates a timing diagram depicting handover behavior in wireless networks, showing the movement of a client device between wireless networks and comparing predicted handover locations with traditional handover locations.

FIG. 3 illustrates a component diagram of a client device configured for privacy-preserving handover predictions, showing processors, network interfaces, sensors, memory components, and data storage elements.

FIG. 4 illustrates a component diagram of a wireless network system configured to provide privacy-preserving handover predictions, showing processors, network interfaces, data storage, and functional components for processing anonymous mobility queries.

FIGS. 5A and 5B illustrate example handover prediction request message formats transmitted from client devices to wireless networks using randomized MAC addresses and motion data.

FIGS. 6A and 6B illustrate example handover prediction response message formats transmitted from wireless networks to client devices, providing handover timing and target access point information.

FIG. 7 illustrates a flow diagram of a method performed by a wireless network system for privacy-preserving handover prediction using anonymous mobility queries from client devices.

FIG. 8 illustrates a flow diagram of a method performed by a client device for privacy-preserving handover prediction using anonymous mobility queries transmitted to wireless networks.

FIG. 9 is a computer architecture diagram showing an example computer architecture for a device capable of executing program components that can be utilized to implement aspects of the various technologies presented herein.

### DESCRIPTION OF EXAMPLE EMBODIMENTS

### OVERVIEW

This disclosure describes techniques for privacy-preserving handover predictions in wireless communication networks using anonymous mobility queries to enable proactive handover decisions while maintaining client device anonymity.

A first method to perform techniques described herein includes receiving a handover prediction request from a client device connected to the first wireless network, the handover prediction request including motion data and being transmitted using a randomized Media Access Control (MAC) address that is different from a MAC address of the client device that was used to connect to the first wireless network. In some instances, the handover prediction request can also be realized using an existing IEEE 802.11 frame type/message without requiring a new message type, for example 802.11K Neighbor Report Request can be repurposed for this exchange.

The first method further includes determining, using the motion data, that the client device is moving away from a first access point of the first wireless network to a second access point of a second wireless network, the second wireless network being different than the first wireless network. The first method further includes predicting, using the motion data, a time or a location at which the client device is to handover from the first access point to the second access point, and transmitting a handover prediction response using the randomized MAC address to the client device, the handover prediction response indicating the time or the location at which the client device is to handover to the second access point.

The handover prediction response may also include guidance for preparing secondary radio interfaces. For example, when the network determines that the predicted handover involves a transition from Wi-Fi to a cellular network, the response may advise the station to begin activating or warming up its cellular interface. This early preparation helps reduce delays associated with scanning, registration, or link setup, allowing the device to complete the eventual handover with minimal interruption to applications.

In some instances, the techniques described herein include a second method that includes detecting, using sensor data, movement of a client device, and generating a handover prediction request including motion data representing the movement of the client device. The second method further includes generating an anonymized media access control (MAC) address, wherein the client device established a connection to a first access point of a first wireless network using a MAC address different than the anonymized MAC address. The second method further includes transmitting the handover prediction request to the network using the anonymized MAC address to preserve device anonymity of the client device, and receiving a handover prediction response indicating a time or a location at which the client device is to handover to a second access point of a second wireless network.

Additionally, the techniques of at least the first method and the second method, and any other techniques described herein, may be performed by a system and/or device having non-transitory computer-readable media storing computer-executable instructions that, when executed by one or more processors, performs the method(s) described above.

### EXAMPLE EMBODIMENTS

Wireless communication networks rely on handover mechanisms to maintain connectivity as mobile devices move between different coverage areas, transitioning from one access point to another or between different access technologies such as Wi-Fi and cellular networks. Current handover implementations typically employ reactive approaches where devices monitor signal strength and initiate handovers only after detecting deteriorated conditions. This reactive methodology introduces substantial latency, with measurements indicating handover completion times of approximately 20-24 seconds in real-world deployments. During these extended transition periods, applications experience service interruptions, connectivity drops, and degraded performance that directly impacts user satisfaction.

The reactive handover problem becomes particularly pronounced in scenarios involving “sticky” client behavior, where devices maintain connections to suboptimal access points despite the availability of superior alternatives. For example, mobile devices frequently remain attached to indoor wireless networks even when users move to outdoor locations where cellular connectivity would provide better service quality. This stickiness stems from historical cost considerations and default device behaviors that prioritize wireless local area network connections over cellular alternatives, regardless of actual signal quality or user location.

The client device may also express motion in relative terms instead of providing precise coordinates. In this approach, the station describes its movement with respect to known access points or coverage regions. For example, the device may indicate that it is moving away from the serving access point, approaching a neighboring access point. These relative motion descriptors allow the network to understand directional trends and mobility patterns without requiring exact location data.

Examples of relative descriptors include statements such as “moving away from the current access point,” “approaching the overlap region between AP-2 and AP-3,” or “at the far boundary of AP-4’s coverage.” Such descriptors provide the network with enough information to match the anonymous request to a predicted trajectory and use it in handover prediction logic.

Beyond latency concerns, existing handover mechanisms lack environmental awareness and predictive capabilities. Some techniques contemplate reliance on generic signal strength thresholds that fail to account for venue-specific characteristics, building layouts, access point positioning, or historical mobility patterns. However, these approaches cannot anticipate handover events or provide proactive guidance to client devices, resulting in suboptimal transition timing and frequent service disruptions.

The fundamental tension between network assistance and privacy protection creates additional challenges for improving handover performance. Network infrastructure possesses valuable environmental knowledge including venue layouts, access point locations, radio frequency characteristics, and historical mobility data from thousands of daily user sessions. This information enables accurate prediction of handover timing and locations based on user movement patterns. However, generating accurate predictions requires real-time motion data from client devices, including location information, movement direction, speed, and trajectory data that device manufacturers consider privacy-sensitive.

Client device vendors, particularly companies emphasizing privacy protection, refuse to share detailed motion information with network infrastructure due to privacy concerns. This creates a paradoxical situation where networks possess the environmental knowledge necessary for handover optimization, but lack the real-time motion data required to generate accurate predictions.

The techniques described herein enable privacy-preserving handover predictions in wireless communication networks using anonymous mobility queries to provide proactive handover guidance while maintaining client device anonymity. A client device generates a randomized Media Access Control (MAC) address that is different from the MAC address used to connect to the wireless network, and transmits a handover prediction request including motion data using the randomized MAC address to preserve device anonymity. A wireless network system receives the handover prediction request and determines using the motion data that the client device is moving away from a first access point of a first wireless network to a second access point of a second wireless network, predicts a time or location at which the client device is to handover between the access points, and transmits a handover prediction response using the randomized MAC address to provide handover guidance without identifying the specific client device. The motion data may include location information, speed, and direction of movement, enabling the network to leverage venue layout information, access point locations, and historical mobility patterns to generate accurate handover predictions while the randomized MAC address prevents correlation of the request to the client device's actual identity, thereby solving the privacy concerns that previously prevented network-assisted handover optimization.

Client devices initiate the privacy-preserving handover process through motion detection using one or more hardware sensors such as accelerometers, gyroscopes, magnetometers, and GPS receivers. These sensors generate sensor data representing movement characteristics such as acceleration, rotation, magnetic field orientation, and position changes. The client device processes the sensor data to detect significant movement patterns that indicate potential handover scenarios, such as changes in location, speed, direction, or trajectory that suggest the device may be approaching network boundaries or coverage transition zones.

Upon detecting significant movement, the client device generates motion data that includes location information, speed measurements, and directional vectors representing the movement characteristics. The location information may be provided at different granularity levels based on privacy preferences, ranging from precise coordinates to general coverage zones or relative positioning descriptions. The speed measurements indicate the velocity of device movement, while directional vectors specify the heading or trajectory of the client device movement pattern.

The client device generates a randomized MAC address specifically for the handover prediction query, distinct from the MAC address used to establish the original network connection. This randomized MAC address serves as a one-time identifier that prevents correlation between the handover prediction request and the client device identity. The randomized MAC address generation process ensures that each handover prediction query uses a unique identifier that cannot be linked to previous queries or the established network session.

The client device transmits the handover prediction request using the randomized MAC address and includes the motion data within the request payload. The handover prediction request may be encrypted using broadcast or multicast keys distributed by the wireless network to authenticated client devices. This encryption approach ensures that only legitimate network participants can generate valid handover prediction requests while maintaining the anonymity of the requesting device. The encrypted transmission prevents unauthorized devices from accessing handover prediction services or learning network topology information.

The wireless network system receives the handover prediction request and processes the included motion data using venue awareness capabilities and trained prediction models. The network system maintains comprehensive venue data including physical building layouts, access point locations, RF propagation characteristics, and environmental factors that influence wireless connectivity. This venue awareness enables the network to understand the spatial relationships between access points and identify typical handover locations based on the physical environment.

The network system employs trained prediction models that have been developed using historical mobility data from many client device sessions and users. These machine learning models analyze patterns of movement and handover behavior to identify locations where connectivity transitions typically occur. The prediction models incorporate access point locations, historical motion data, venue layout information, and RF characteristics to generate accurate predictions of handover timing and locations.

Using the motion data from the handover prediction request, the network system determines that the client device may be moving away from the current access point toward a different network coverage area. The system analyzes the speed, direction, and location information to predict the trajectory of the client device and identify potential handover scenarios. The prediction process considers whether the client device may be transitioning between access points within the same wireless network or moving toward a different wireless technology such as cellular networks.

The randomized MAC addresses distributed by the network may, in some examples, be used exclusively for anonymous mobility queries. These addresses are not used for association, data transmission, or periodic MAC address rotation, and they do not correspond to or identify any specific STA. A given randomized address is not bound to a single device and may be safely reused within an anonymity set without enabling device tracking.

In some implementations, the concept of network-provided temporary MAC addresses may be useful for other short-lived or task-specific communications. In these cases, the network may issue a pool of anonymous addresses for use only during a particular exchange, such as a brief discovery procedure or a limited interaction that does not require persistent device identity. These temporary addresses are not tied to any specific station, and are used only for a defined and bounded purpose. This approach maintains unlinkability while allowing the network to facilitate controlled, privacy-preserving communication sessions when needed.

The network system generates time-based or location-based predictions indicating when or where the client device should perform a handover operation. Time-based predictions specify the number of seconds until handover becomes advisable, while location-based predictions indicate the distance or geographic position where handover should occur. The prediction system ensures that handover recommendations are provided while the client device maintains signal strength above threshold levels, enabling proactive transitions before service quality degrades.

The network system generates a handover prediction response that includes the predicted handover timing or location information along with additional guidance such as target access point identifiers or recommended access technologies. The response may specify confidence levels for the predictions and provide recommended actions for the client device to prepare for the anticipated handover. The handover prediction response uses the same randomized MAC address from the original request to ensure proper delivery while maintaining anonymity.

The client device receives the handover prediction response and utilizes the provided guidance to prepare for the anticipated handover operation. The client device may begin scanning for target access points, preparing cellular connections, or adjusting application behavior based on the predicted handover timing. This proactive preparation enables smoother transitions with reduced service interruption compared to reactive handover approaches.

The wireless network system manages MAC address pools by generating sets of randomized MAC addresses and securely distributing these addresses to authenticated client devices. The MAC address pool management prevents unauthorized devices from generating valid handover prediction requests while enabling legitimate client devices to maintain anonymity. The system periodically rotates the MAC address pools and redistributes updated addresses to connected client devices to maintain security and prevent potential correlation attacks.

The system implements crowd anonymity thresholds by monitoring the number of client devices connected to each access point and enabling handover prediction queries only when sufficient device activity exists to maintain anonymity. Client devices assess network activity levels before transmitting handover prediction requests to ensure that anonymous queries cannot be easily attributed to specific devices. This crowd anonymity approach provides additional privacy protection in environments with limited client device populations.

The privacy-preserving handover system creates an ecosystem where client devices can obtain network-assisted handover guidance without compromising device privacy or revealing sensitive location and movement information. The system enables networks to provide valuable handover assistance based on environmental knowledge and historical patterns while preventing tracking or identification of individual client devices. This ecosystem balances the benefits of network-assisted handover optimization with privacy protection requirements.

The system supports continuous machine learning improvements through ongoing analysis of handover patterns and prediction accuracy. The trained prediction models adapt to changing environmental conditions, new access point deployments, and evolving user mobility patterns. The machine learning approach enables the system to improve prediction accuracy over time while maintaining privacy protection through anonymous data collection and processing.

The handover prediction engine may be deployed in different network locations to optimize performance and scalability. The engine may be co-located with access points for low-latency processing, deployed in wireless LAN controllers for centralized management, or implemented as cloud-based functions for enhanced computational capabilities. The distributed deployment options enable flexible system architectures that can adapt to different network configurations and performance requirements.

The system provides device-specific handover predictions that account for different device manufacturers and their varying chipset capabilities and threshold configurations. Apple devices and Samsung devices may exhibit different handover behaviors due to distinct hardware characteristics and pre-configured signal strength thresholds. The prediction models incorporate device-specific parameters to generate customized handover recommendations that align with the particular behavior patterns of different device types.

The handover prediction request may include application identifiers that enable application-aware handover optimization for different types of network applications. Latency-sensitive applications such as augmented reality and virtual reality require earlier handover initiation to maintain acceptable performance levels, while tolerant applications such as web browsing and video streaming can accommodate greater signal degradation before handover becomes necessary. The application-aware approach enables customized handover timing based on the specific requirements of active applications.

The system applies to cellular-to-WiFi handover scenarios where cellular networks predict when users enter venues with poor cellular coverage and recommend WiFi network scanning. Cellular networks may identify locations such as buildings with thick glass or underground areas where cellular signal quality typically degrades. The cellular network can provide proactive guidance for client devices to begin scanning for available WiFi networks before cellular connectivity becomes insufficient, enabling seamless transitions between cellular and WiFi technologies.

The privacy-preserving handover prediction system provides substantial technical benefits including reduced handover latency, improved user experience, enhanced network efficiency, and maintained privacy protection. The proactive approach enables handover decisions before signal quality degradation, resulting in smoother transitions and reduced service interruptions. The system leverages network environmental knowledge and machine learning capabilities to provide superior handover guidance compared to client-side heuristic approaches while preserving client device anonymity through randomized MAC addresses and encrypted communications.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

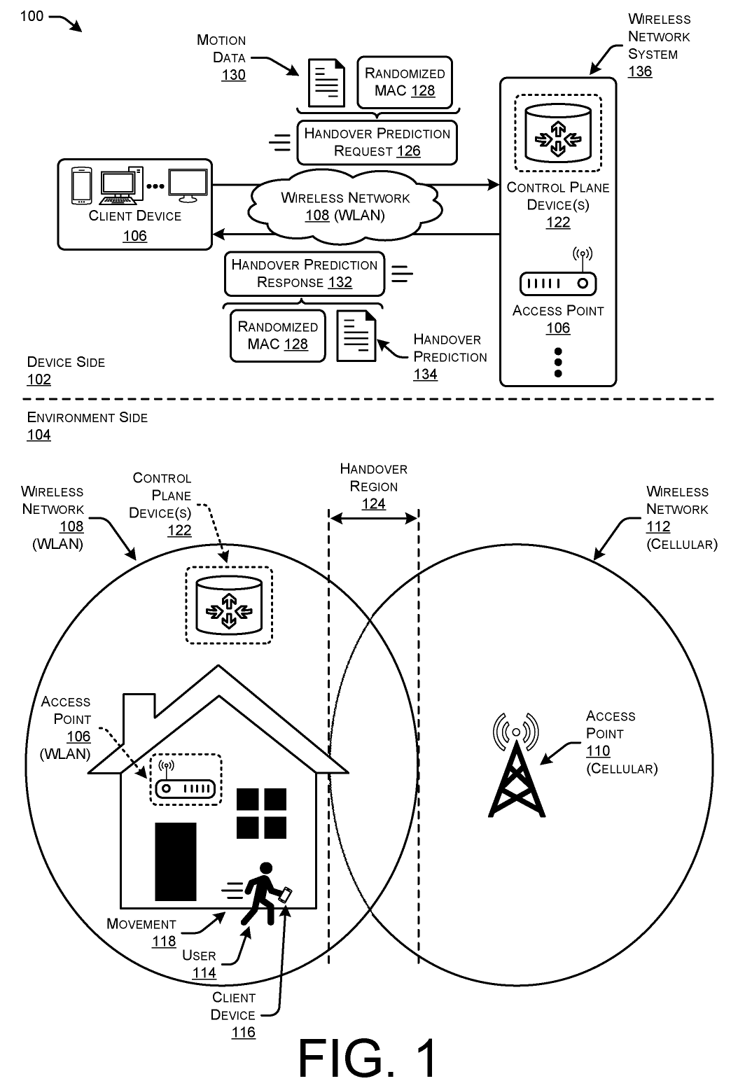

FIG. 1 illustrates a system architecture 100 for privacy-preserving handover predictions using anonymous mobility queries in wireless communication networks. The system architecture 100 is divided into a device side 102 and an environment side 104, showing the interaction between client devices and network infrastructure during handover prediction operations.

The system architecture 100 demonstrates a comprehensive framework for enabling proactive handover decisions while maintaining client device privacy through anonymization techniques. A device side 102 represents the client-facing components of the system architecture 100, encompassing the mobile devices and their associated movement patterns within wireless coverage areas. An environment side 104 represents the network infrastructure components that process handover prediction requests and generate predictive responses based on venue characteristics and historical mobility data.

On the device side 102, a client device 116 establishes connectivity to a wireless network 108 through an access point 106. The client device 116 may be any mobile computing device capable of wireless communication, including smartphones, tablets, laptops, or other portable electronic devices equipped with wireless networking capabilities. The wireless network 108 may comprise a wireless local area network (WLAN) operating according to IEEE 802.11 standards, providing data connectivity services to connected client devices. The access point 106 serves as a network infrastructure device that facilitates wireless communication between the client device 116 and the wireless network 108, managing radio frequency transmissions and network access protocols.

A user 114 carries a client device 116 and exhibits movement 118 within the coverage area of the wireless network 108. The client device 116 may be the same device as the client device 116 or may represent a different mobile device within the system architecture 100. The movement 118 represents the physical displacement of the user 114 and the client device 116 through different geographic locations, which may result in changes to signal strength, coverage quality, and proximity to various access points. The client device 116 generates motion data 130 based on sensor inputs that detect and quantify the movement 118, including parameters such as speed, direction, trajectory, and location information.

The system architecture 100 includes a handover region 124 that represents a geographic area where handover events typically occur as mobile devices transition between different network coverage zones. The handover region 124 may encompass areas of overlapping coverage between multiple access points, such as access point 106 and access point 110, boundary zones where signal strength begins to degrade, or transition areas between different types of wireless networks such as Wi-Fi and cellular networks. Within the handover region 124, the client device 116 formulates and transmits a handover prediction request 126 to the network infrastructure.

The handover prediction request 126 incorporates a randomized MAC 128 and motion data 130 to enable anonymous querying of the network for handover guidance. The randomized MAC 128 comprises a Media Access Control address that differs from the actual MAC address used by the client device 116 to establish its connection to the wireless network 108, thereby preventing correlation between the handover prediction request 126 and the specific device identity. The motion data 130 includes movement parameters such as current location, speed, direction, and trajectory information that enable the network infrastructure to perform predictive analysis without compromising device anonymity.

On the environment side 104, a control plane device 122 receives and processes the handover prediction request 126 from the client device 116. The control plane device 122 may comprise network management hardware and software components responsible for analyzing mobility patterns and generating handover predictions. The control plane device 122 operates as part of a wireless network system 136 that encompasses the broader network infrastructure supporting handover prediction services.

The wireless network system 136 includes computational resources, data storage systems, and predictive algorithms that analyze the motion data 130 in conjunction with venue layout information, access point locations, and historical mobility patterns. The wireless network system 136 processes the anonymous handover prediction request 126 to determine optimal handover timing, target access points, or alternative network technologies for the requesting client device.

Based on the analysis performed by the wireless network system 136, a handover prediction response 132 is generated and transmitted back to the client device 116. The handover prediction response 132 contains predictive information regarding handover timing, location, or target access point recommendations. The handover prediction response 132 is delivered to the client device 116 as a handover prediction response 134, providing actionable guidance for proactive handover execution while maintaining the anonymity established through the randomized MAC 128.

The system architecture 100 also includes a wireless network 112 that represents an alternative network to which the client device 116 may perform a handover operation. The wireless network 112 may comprise a different wireless local area network, a cellular network, or another type of wireless communication system that provides connectivity services in the geographic area. The wireless network 112 serves as a potential handover target when the client device 116 moves away from the coverage area of the wireless network 108 or when network conditions indicate that a handover would improve connectivity quality or user experience.

The handover prediction system may facilitate transitions between various types of wireless networks beyond the traditional Wi-Fi to cellular scenarios. The system may support handovers between different Wi-Fi networks operating on separate frequency bands, such as transitions from 2.4 GHz to 5 GHz networks or from Wi-Fi 5 to Wi-Fi 6E networks that utilize the 6 GHz spectrum. The prediction capabilities may extend to handovers between different wireless technologies including Bluetooth networks, Zigbee networks, or other Internet of Things (IoT) communication protocols that operate in proximity to the client device. In some cases, the system may predict handovers between different cellular network technologies, such as transitions from 4G LTE to 5G networks, or between different cellular carriers when roaming agreements enable such transitions. The handover prediction framework may also apply to satellite communication networks, mesh networks, or ad-hoc wireless networks that provide connectivity in specific geographic areas. Additionally, the system may support handovers to wired network connections through technologies such as Power over Ethernet (PoE) or USB-C connections when client devices enter docking stations or connect to fixed network infrastructure, enabling seamless transitions between wireless and wired connectivity modes based on user movement patterns and network availability.

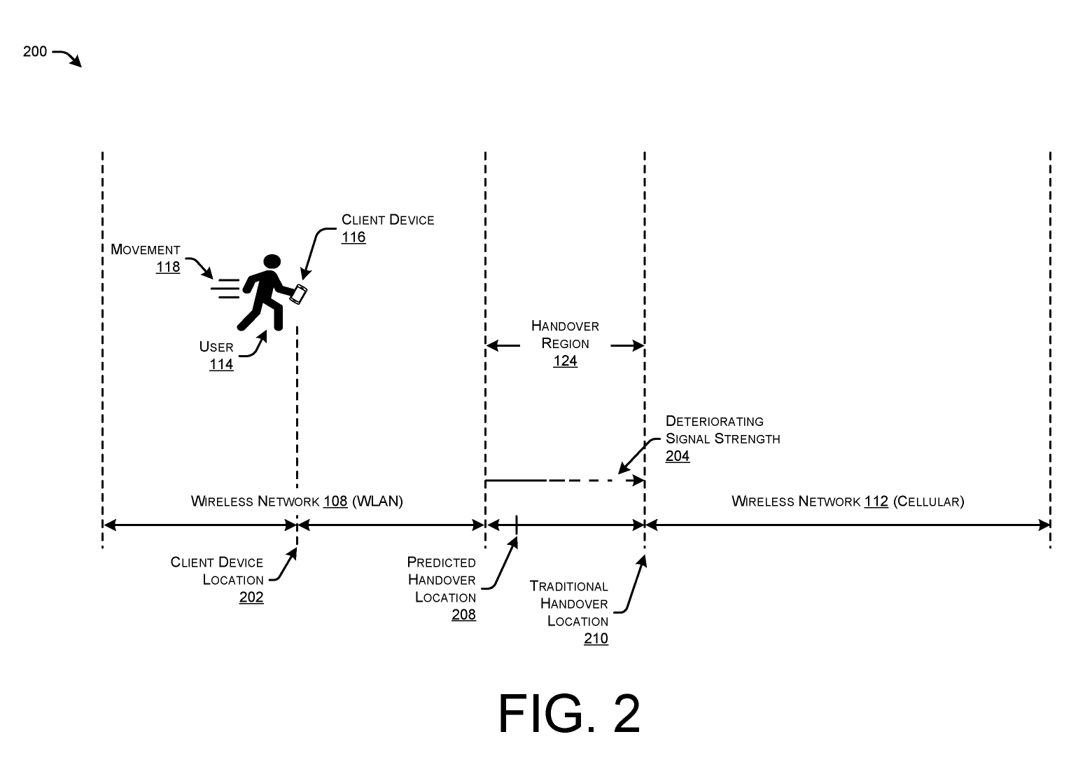

FIG. 2 illustrates a timing diagram 200 depicting handover behavior in wireless networks, showing the movement of a client device between wireless networks and comparing predicted handover locations with traditional handover locations. The diagram shows a client device location 202 moving horizontally across two wireless networks: wireless network 108 (WLAN) on the left side and wireless network 112 (cellular) on the right side. A user 114 is shown with a client device 116 experiencing movement 118, indicated by motion lines. The diagram includes a handover region 124 positioned between the two wireless networks, representing the transition zone where handover decisions occur.

The timing diagram 200 demonstrates the trajectory of the client device location 202 as the user 114 moves the client device 116 from the coverage area of wireless network 108 toward wireless network 112. The movement 118 of the client device 116 through the handover region 124 triggers the handover prediction process described herein. As the client device 116 traverses this path, deteriorating signal strength 204 from wireless network 108 becomes evident, shown as a declining line that indicates the degradation of the wireless signal as the client device 116 moves away from the WLAN coverage area.

The timing diagram 200 illustrates two distinct handover points that demonstrate the temporal advantage provided by the privacy-preserving handover prediction system. A predicted handover location 208 represents the proactive handover point determined by the network-assisted prediction system, while a traditional handover location 210 represents the reactive handover point that would occur using conventional approaches. The predicted handover location 208 occurs earlier in the movement trajectory compared to the traditional handover location 210, demonstrating that the proactive approach initiates handover before signal quality significantly degrades.

The spacing between the predicted handover location 208 and the traditional handover location 210 illustrates the temporal advantage provided by the privacy-preserving handover prediction system. By initiating handover at the predicted handover location 208, the client device 116 transitions between wireless network 108 and wireless network 112 while maintaining better signal quality and reducing service interruption. The deteriorating signal strength 204 shows that at the predicted handover location 208, the signal strength remains above acceptable thresholds, whereas at the traditional handover location 210, the signal strength has degraded to levels that may impact user experience. This proactive handover approach reduces the latency associated with reactive handover methods and provides improved continuity of network connectivity for the client device 116.

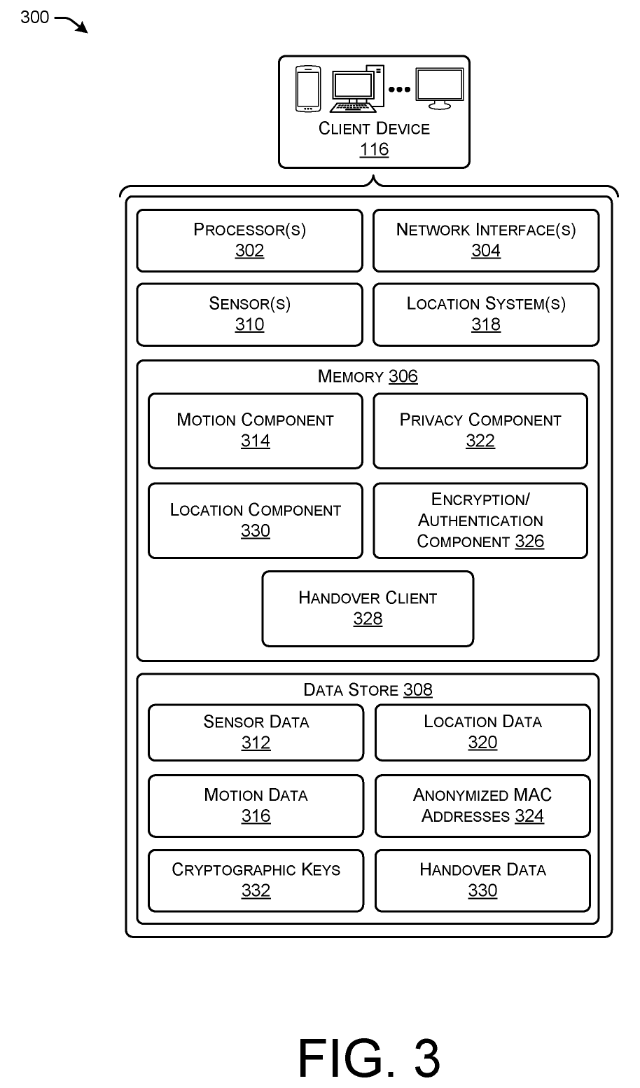

FIG. 3 illustrates a component diagram 300 of a client device 116 configured for privacy-preserving handover predictions. The client device 116 includes processor(s) 302, network interface(s) 304, sensor(s) 310, and location system(s) 318. The client device 116 further includes memory 306 and data store 308.

The client device 116 includes one or more processors 302 that execute software components and coordinate operations of the various hardware and software elements. A network interface 304 facilitates communication with wireless networks, enabling transmission of handover prediction requests and reception of handover prediction responses. The network interface 304 supports wireless communication protocols and manages network connectivity for the client device 116.

The client device 116 incorporates one or more sensors 310 that generate data representing movement and orientation of the device. The sensors 310 may include motion sensors and approximately ten other sensors that continuously track movement characteristics. The sensors 310 detect significant movement such as changes in location, speed, direction, or trajectory that indicate when handover prediction assistance may be beneficial. The multi-sensor configuration enables the client device 116 to distinguish between meaningful movement patterns that warrant handover prediction queries and non-relevant movement such as stationary positioning or circular motion.

A location system 318 determines geographic position information for the client device 116. The location system 318 may utilize various positioning technologies including Global Positioning System (GPS), Wi-Fi positioning, cellular tower triangulation, or other location determination methods. The location system 318 provides location data that forms part of the motion information shared in handover prediction requests.

The memory 306 stores several software components that operate during runtime to provide privacy-preserving handover functionality. A motion component 314 processes sensor data to detect and analyze device movement patterns. The motion component 314 determines when the client device 116 experiences significant movement that warrants initiating a handover prediction request to the network infrastructure.

A privacy component 322 manages anonymization functions to preserve user privacy during handover prediction operations. The privacy component 322 generates and manages randomized MAC addresses that prevent correlation of handover prediction requests to the actual device identity. The privacy component 322 ensures that handover prediction queries remain anonymous and cannot be linked to the client device 116 or user identity.

A location component 330 determines and manages location information for inclusion in handover prediction requests. The location component 330 processes data from the location system 318 and allows the client device 116 to control the granularity of location information shared with the network. The location component 330 may provide precise coordinates, general location zones, or relative positioning information based on privacy preferences and system requirements.

An encryption/authentication component 326 handles cryptographic operations and authentication procedures for secure communication with wireless networks. The encryption/authentication component 326 manages encryption keys and performs authentication processes that enable the client device 116 to participate in secure handover prediction operations while maintaining anonymity.

A handover client 328 coordinates the handover prediction request and response process with wireless network infrastructure. The handover client 328 generates handover prediction requests containing motion data and anonymized addressing information, transmits the requests to network systems, and processes handover prediction responses to facilitate proactive handover decisions.

The data store 308 maintains various types of information used during handover prediction operations. Sensor data 312 contains raw data collected from the sensors 310, including movement measurements, orientation information, and other sensor readings. Location data 320 stores position information obtained from the location system 318, which may include coordinates, zone identifiers, or relative positioning data.

Motion data 316 includes processed movement information such as speed, direction, and trajectory that has been derived from the sensor data 312. The motion data 316 represents the movement characteristics that are shared with network infrastructure in handover prediction requests. Anonymized MAC addresses 324 comprise a pool of randomized MAC addresses received from network infrastructure and used for anonymous handover prediction queries. The anonymized MAC addresses 324 enable the client device 116 to make handover prediction requests without revealing device identity.

Cryptographic keys 332 store encryption keys such as broadcast keys or multicast keys received from wireless networks. The cryptographic keys 332 enable the client device 116 to encrypt handover prediction requests and participate in secure communication with network infrastructure while maintaining anonymity.

The components of the client device 116 interact to provide comprehensive handover prediction functionality. The sensors 310 continuously monitor device movement and generate sensor data 312 that is processed by the motion component 314. When the motion component 314 detects significant movement, the handover client 328 coordinates with the privacy component 322 to generate an anonymous handover prediction request using one of the anonymized MAC addresses 324. The location component 330 contributes location information to the request, while the encryption/authentication component 326 secures the communication using the cryptographic keys 332. The network interface 304 transmits the request to network infrastructure and receives handover prediction responses that guide proactive handover decisions.

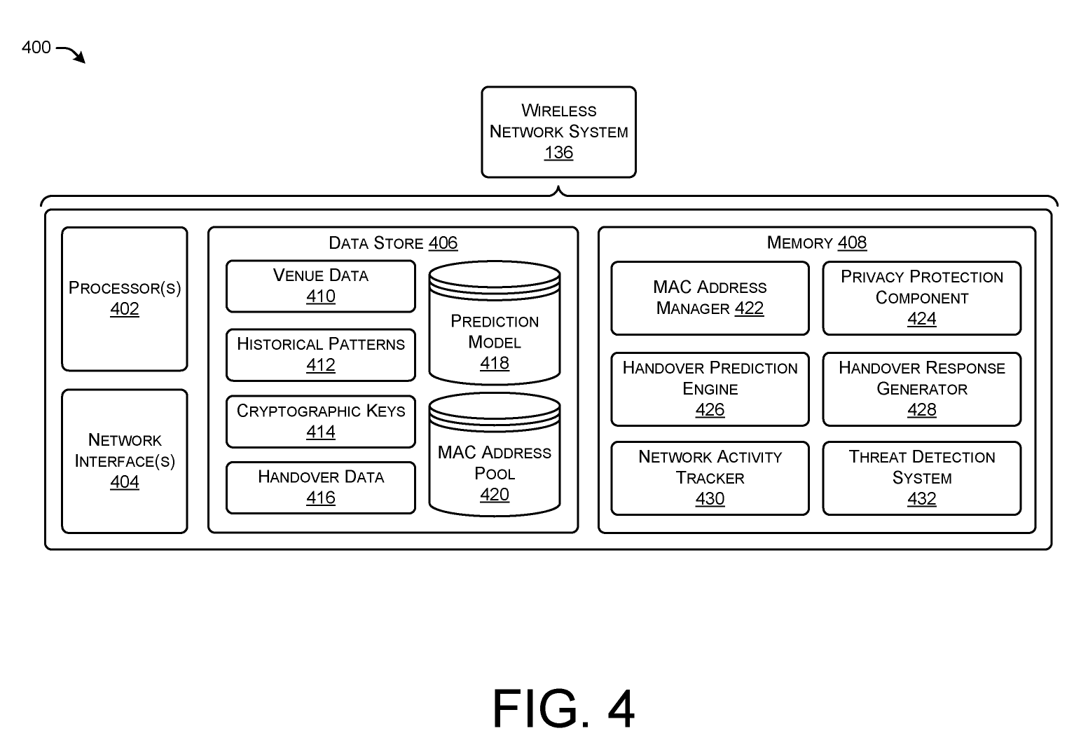

FIG. 4 illustrates a component diagram 400 of a wireless network system 136 configured to provide privacy-preserving handover predictions. The wireless network system 136 includes one or more processors 402 and one or more network interfaces 404 for communicating with client devices and other network components. The system 136 further includes a data store 406 and memory 408 for storing and processing various types of information.

The wireless network system 136 includes one or more processors 402 that execute functional components and process data to provide handover prediction services. A network interface 404 facilitates communication with client devices, access points, and other network infrastructure components. The processors 402 coordinate with the network interface 404 to receive handover prediction requests and transmit handover prediction responses while maintaining client device anonymity.

A data store 406 contains multiple types of information used for handover prediction operations. Venue data 410 includes information about physical layouts, access point locations, and environmental characteristics of the deployment venue. The venue data 410 encompasses building maps, RF propagation characteristics, coverage boundaries, and physical obstacles that affect wireless signal transmission. Historical patterns 412 represent past mobility and handover behaviors of client devices, capturing movement trajectories, handover timing, and transition points observed across thousands of user sessions. Cryptographic keys 414 store encryption keys such as broadcast keys and multicast keys used for secure communications with authenticated client devices. Handover data 416 contains information about previous handover events, including success rates, timing measurements, and performance metrics. A prediction model 418 is trained on historical data to predict handover timing and locations based on motion parameters and environmental conditions. A MAC address pool 420 contains randomized MAC addresses that are distributed to authenticated client devices for use in anonymous handover prediction queries.

The prediction model 418 undergoes comprehensive training using multiple data sources to achieve accurate handover predictions. The training data includes venue layout information that describes physical building structures, room configurations, and architectural features that influence wireless signal propagation. Access point locations provide precise positioning data for all wireless infrastructure components within the deployment environment. Historical mobility data from thousands of user sessions captures movement patterns, speed variations, directional changes, and handover transition points observed over extended periods. RF characteristics data includes signal strength measurements, coverage maps, interference patterns, and propagation models specific to the deployment venue. Entry and exit point data identifies locations where client devices typically transition between different wireless networks or coverage areas.

Memory 408 contains several functional components that operate during runtime to process handover prediction requests. A MAC address manager 422 generates and manages the pool of randomized MAC addresses used for anonymous queries. The MAC address manager 422 creates new randomized addresses, distributes address pools to authenticated client devices, and implements periodic rotation schedules to maintain anonymity. A privacy protection component 424 ensures that handover prediction requests cannot be correlated to specific client device identities. The privacy protection component 424 validates that randomized MAC addresses are used properly and prevents linkage between anonymous queries and device authentication sessions.

A handover prediction engine 426 processes motion data from client devices and generates predictions using the prediction model 418, venue data 410, and historical patterns 412. The handover prediction engine 426 analyzes speed, direction, trajectory, and location information to determine when and where handover events will occur. The handover prediction engine 426 may be deployed in different network locations to optimize performance and scalability. In some cases, the handover prediction engine 426 is co-located with access points to provide low-latency processing of handover prediction requests. In other cases, the handover prediction engine 426 operates within wireless LAN controllers to centralize prediction processing across multiple access points. The handover prediction engine 426 may also function as a cloud-based service to leverage distributed computing resources and enable predictions across multiple deployment venues.

A handover response generator 428 creates handover prediction responses containing timing, location, or target access point information. The handover response generator 428 formats prediction results into appropriate message structures and addresses responses using the randomized MAC addresses provided in the corresponding requests. A network activity tracker 430 monitors the number and behavior of connected client devices to support anonymity thresholds. The network activity tracker 430 maintains counts of active client devices and provides information used to determine when sufficient network activity exists to preserve client anonymity during handover prediction operations.

A threat detection system 432 identifies potential security threats such as unauthorized queries or denial-of-service attacks. The threat detection system 432 monitors query frequency patterns, validates MAC address usage, and detects anomalous behavior that may indicate malicious activity. The threat detection system 432 implements denial-of-service attack mitigation by monitoring the frequency of handover prediction queries from individual MAC addresses. When the threat detection system 432 detects excessive queries using a particular randomized MAC address, the system immediately triggers rotation of the MAC address pool 420. The MAC address manager 422 generates a new set of randomized MAC addresses and securely distributes the updated pool to all authenticated client devices connected to the wireless network system 136. This rapid rotation mechanism prevents attackers from overwhelming the handover prediction service while maintaining legitimate access for authenticated client devices.

The components within memory 408 interact to process anonymous queries while preserving client device privacy. When a handover prediction request arrives through the network interface 404, the privacy protection component 424 validates that the request uses a randomized MAC address from the current MAC address pool 420. The handover prediction engine 426 processes the motion data using the prediction model 418 and venue-specific information from the data store 406. The handover response generator 428 creates an appropriate response message and transmits the response through the network interface 404 using the same randomized MAC address to maintain anonymity throughout the transaction.

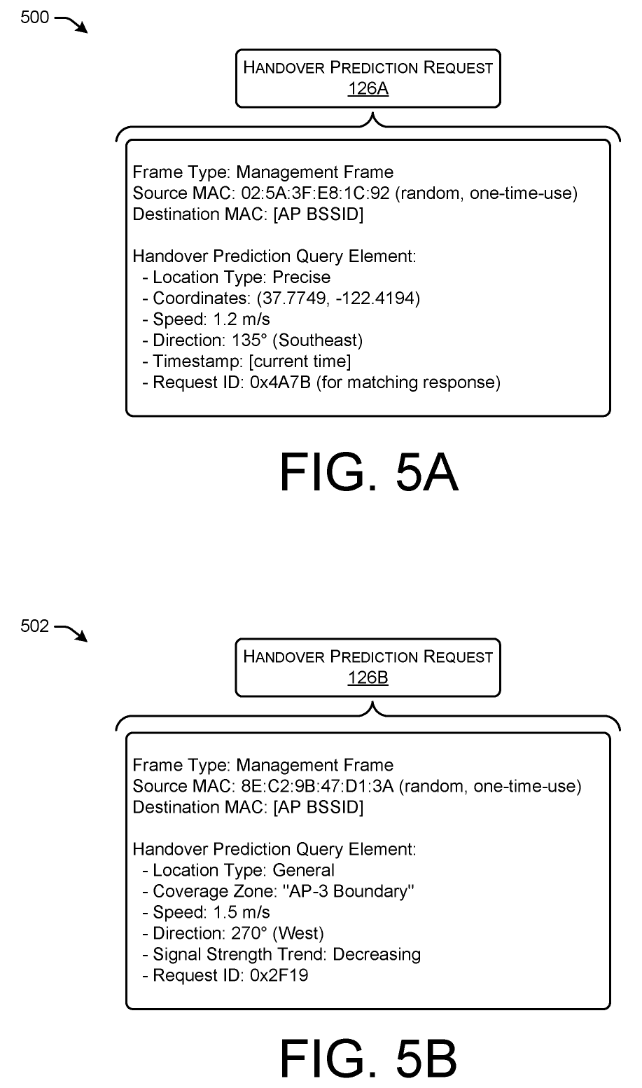

FIGS. 5A-5B depict handover prediction request 500 labeled as handover prediction request 126A and handover prediction request 502 labeled as handover prediction request 126B, showing example message formats for anonymous mobility queries with different levels of location granularity.

As shown in FIG. 5A, a handover prediction request 500 (handover prediction request 126A) demonstrates a management frame structure that enables anonymous handover prediction queries. The handover prediction request 126A includes a source MAC address field containing 02:5A:3F:E8:1C:92, which represents a random, one-time-use address that differs from the MAC address used by the client device to establish the original network connection. The handover prediction request 126A further includes a destination MAC address field corresponding to an access point BSSID. Within the frame body, a handover prediction query element specifies motion data parameters including a location type field set to "precise," coordinates specified as (37.7749, -122.4194), speed indicated as 1.2 m/s, direction specified as 135° (Southeast), a timestamp field containing current time information, and a request ID field set to 0x4A7B for matching with corresponding responses.

FIG. 5B illustrates a handover prediction request 502 (handover prediction request 126B) that demonstrates an alternative message format with reduced location granularity. The handover prediction request 126B includes a source MAC address field containing 8E:C2:9B:47:D1:3A, representing another random, one-time-use address, and a destination MAC address field corresponding to an access point BSSID. The handover prediction query element within the handover prediction request 126B specifies a location type field set to "general," a coverage zone field indicating "AP-3 Boundary," speed specified as 1.5 m/s, direction indicated as 270° (West), a signal strength trend field set to "decreasing," and a request ID field containing 0x2F19.

The handover prediction request 126A and handover prediction request 126B demonstrate variable location granularity capabilities that allow client devices to control the precision of location information shared during handover prediction queries. The handover prediction request 126A provides precise coordinate information, enabling highly accurate handover predictions while maintaining anonymity through the randomized MAC address. In contrast, the handover prediction request 126B shares general location information relative to access point coverage boundaries, offering reduced location precision while maintaining sufficient detail for effective handover prediction.

The handover prediction requests may be implemented using existing 802.11k neighbor report request message formats, eliminating the need for new message types while leveraging established wireless communication protocols. This approach allows the motion data and location information to be encoded within existing information elements or vendor-specific elements of standard 802.11k messages. The motion data fields within both handover prediction request formats support multiple location granularity levels that client devices may select based on privacy preferences and environmental conditions.

Client devices may choose from various location granularity levels when generating handover prediction requests. Precise location information may include exact GPS coordinates or other high-accuracy positioning data. General location information may specify coverage zones, access point boundaries, or overlapping regions between multiple access points. Relative location descriptions may indicate position in relation to serving access points, such as "at the far end of AP coverage" or "moving away from current access point." The flexible location granularity approach enables client devices to balance handover prediction accuracy with privacy protection requirements while maintaining the anonymity provided by randomized MAC addresses.

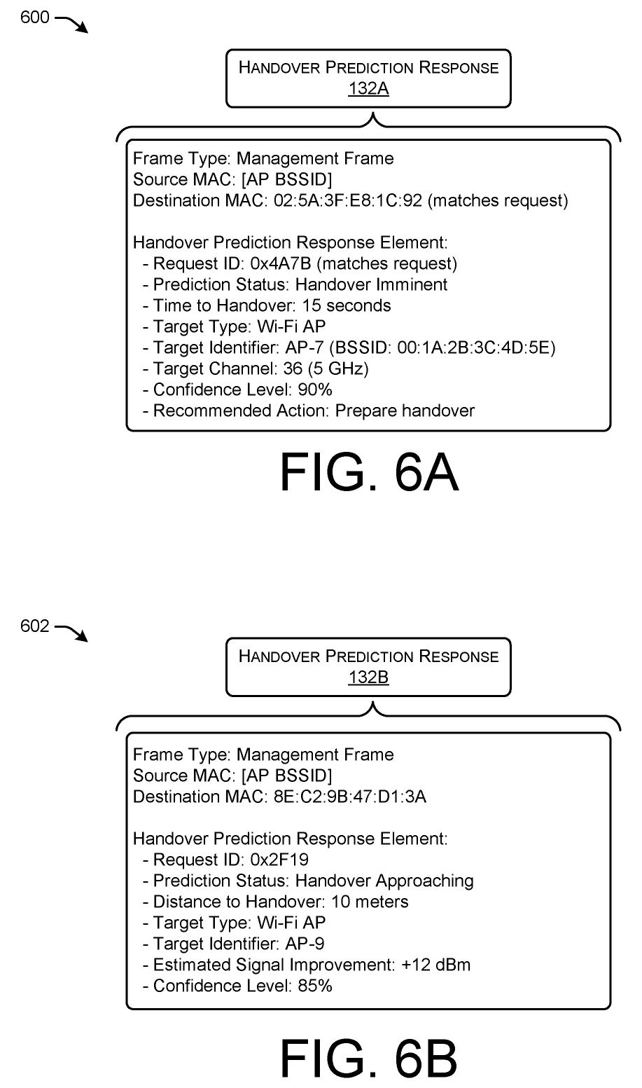

FIGS. 6A and 6B depict two example handover prediction responses 600 and 602 that may be transmitted from a wireless network to a client device in response to handover prediction requests.

As shown in FIG. 6A, a handover prediction response 600 (also labeled as handover prediction response 132A) demonstrates time-based prediction capabilities. The handover prediction response 132A includes a management frame structure with a source MAC address corresponding to an access point BSSID and a destination MAC address of 02:5A:3F:E8:1C:92 that matches the randomized MAC address used in the corresponding request. The response addressing using matching randomized MAC addresses ensures that the handover prediction response 132A reaches the correct client device while maintaining anonymity. The handover prediction response 132A includes a handover prediction response element containing a request ID of 0x4A7B that matches the original request, enabling proper correlation between queries and responses.

The message structure of handover prediction response 132A includes prediction status fields indicating "handover imminent" and timing information specifying a time to handover of 15 seconds. Target access point identification is provided through a target identifier of AP-7 with BSSID 00:1A:2B:3C:4D:5E, and channel information specifies target channel 36 at 5 GHz. The handover prediction response 132A demonstrates probability confidence levels through a confidence level field indicating 90% certainty in the prediction. The response includes a recommended action field instructing the client device to prepare handover, representing target technology recommendation variations where the response indicates a specific Wi-Fi access point for the transition.

As illustrated in FIG. 6B, a handover prediction response 602 (also labeled as handover prediction response 132B) provides distance-based prediction capabilities. The handover prediction response 132B includes a management frame with a source MAC address corresponding to an access point BSSID and a destination MAC address of 8E:C2:9B:47:D1:3A that matches the randomized MAC address from the corresponding request. The handover prediction response 132B includes a handover prediction response element containing a request ID of 0x2F19 for proper request-response correlation.

The handover prediction response 132B demonstrates distance-based predictions through a distance to handover field specifying 10 meters rather than time-based predictions. The prediction status fields indicate "handover approaching" and the target access point identification specifies AP-9 as the recommended handover target. The handover prediction response 132B includes an estimated signal improvement field indicating +12 dBm, providing additional guidance for the handover decision. Probability confidence levels are represented through a confidence level field showing 85% certainty in the distance-based prediction.

Both handover prediction responses 132A and 132B demonstrate target technology recommendation variations where responses may indicate Wi-Fi access points as handover targets. In alternative implementations, the handover prediction responses may indicate cellular network transitions by specifying cellular technology as the target type and including instructions to prepare cellular link activation, enabling seamless transitions between different access technologies while maintaining the anonymous query-response framework.

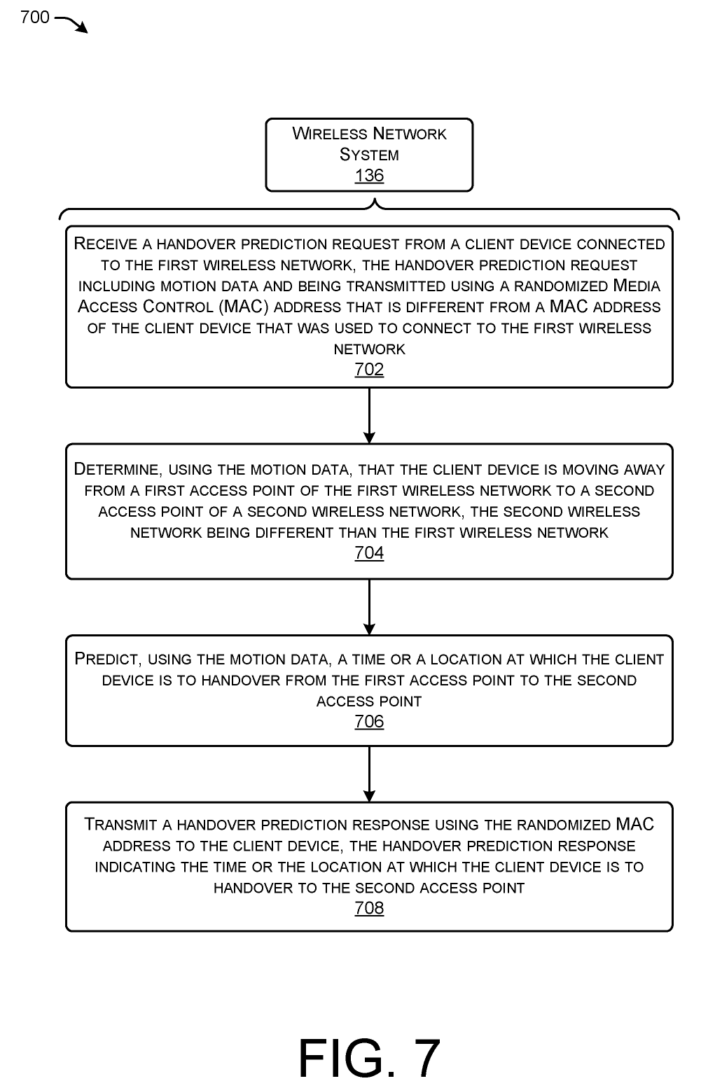

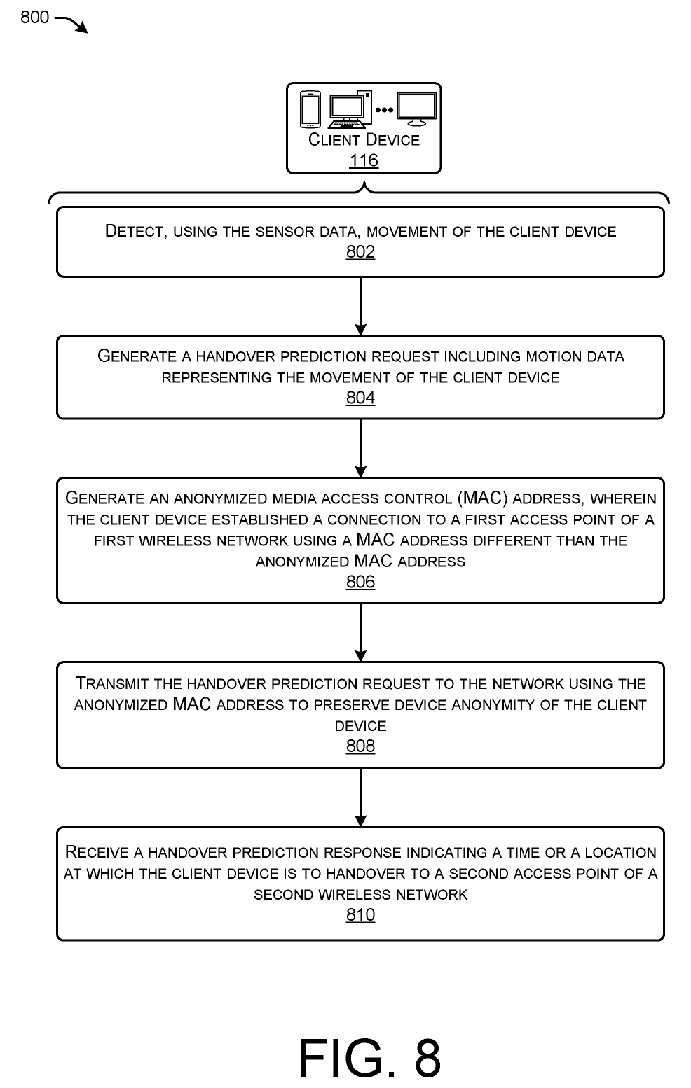

FIGS. 7 and 8 illustrate flow diagrams of example methods 700 and 800 that illustrate aspects of the functions performed at least partly by the devices described in FIGS. 1-6, such as the client device 116, the wireless network system 136, and so forth. The logical operations described herein with respect to FIGS. 7 and 8 may be implemented (1) as a sequence of computer-implemented acts or program components running on a computing system and/or (2) as interconnected machine logic circuits or circuit components within the computing system.

The implementation of the various components described herein is a matter of choice dependent on the performance and other requirements of the computing system. Accordingly, the logical operations described herein are referred to variously as operations, structural devices, acts, or components. These operations, structural devices, acts, and components can be implemented in software, in firmware, in special purpose digital logic, and any combination thereof. It should also be appreciated that more or fewer operations might be performed than shown in FIGS. 7 and 8 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 700 and 800 may be performed by a device and/or a system of devices that includes one or more processors and one or more non-transitory computer-readable media storing computer-executable instructions that, when executed by the one or more processors, cause the one or more processors to perform operations of methods 700 and 800.

FIG. 7 illustrates a flowchart for a method 700 performed by a wireless network system 136 for privacy-preserving handover prediction.

The wireless network system 136 performs a method 700 that enables privacy-preserving handover predictions while maintaining client device anonymity through the use of randomized MAC addresses. The method 700 includes multiple steps that process anonymous mobility queries from client devices and generate proactive handover guidance based on motion data analysis.

At step 702, the wireless network system 136 may receive a handover prediction request from a client device connected to the first wireless network, the handover prediction request including motion data and being transmitted using a randomized Media Access Control (MAC) address that is different from a MAC address of the client device that was used to connect to the first wireless network. The wireless network system 136 processes the handover prediction request without correlating the randomized MAC address to the actual device identity used for network authentication. The motion data included in the handover prediction request comprises location information, speed, and direction of movement of the client device. The wireless network system 136 validates that the randomized MAC address used by the client device to transmit the handover prediction request is included in a pool of randomized MAC addresses that was previously distributed to authenticated client devices. The wireless network system 136 generates the pool of randomized MAC addresses and sends the pool of randomized MAC addresses to each of a plurality of authenticated client devices connected to the first wireless network. The wireless network system 136 periodically rotates and redistributes the pool of randomized MAC addresses to the authenticated client devices to maintain security and prevent unauthorized access. The handover prediction request may be encrypted using a broadcast key or a multicast key that the wireless network system 136 distributes to authenticated client devices connected to the first access point.

At step 704, the wireless network system 136 may determine, using the motion data, that the client device is moving away from a first access point of the first wireless network to a second access point of a second wireless network, the second wireless network being different than the first wireless network. The wireless network system 136 analyzes the motion data to identify movement patterns that indicate the client device is transitioning between different network coverage areas. The wireless network system 136 processes location information, speed, and direction data to determine the trajectory of the client device relative to access point boundaries. In some cases, the first wireless network comprises a wireless local area network and the second wireless network comprises a cellular network, enabling inter-technology handover predictions.

At step 706, the wireless network system 136 may predict, using the motion data, a time or a location at which the client device is to handover from the first access point to the second access point. The wireless network system 136 utilizes a trained prediction model that is trained to predict times or locations at which client devices are to handover, where the trained prediction model is trained on access point locations, historical motion data, and venue layout information. The time or the location is predicted at least partly using the trained prediction model, which incorporates environmental awareness and historical mobility patterns. The wireless network system 136 determines that the client device will maintain signal strength from the first access point that is above a threshold signal strength at the time or the location at which the client device is to handover to the second access point, enabling proactive handover before signal degradation occurs.

At step 708, the wireless network system 136 may transmit a handover prediction response using the randomized MAC address to the client device, the handover prediction response indicating the time or the location at which the client device is to handover to the second access point. The wireless network system 136 generates the handover prediction response without knowledge of the actual client device identity, maintaining privacy while providing handover guidance. The handover prediction response includes instructions for the client device to prepare to activate a cellular link when the second wireless network comprises a cellular network. The wireless network system 136 addresses the handover prediction response to the same randomized MAC address used in the corresponding handover prediction request, ensuring proper delivery while preserving anonymity.

FIG. 8 illustrates a flowchart for a method 800 performed by a client device 116 for privacy-preserving handover prediction using anonymous mobility queries. The method 800 enables a client device 116 to obtain network-assisted handover guidance while maintaining device anonymity through the use of anonymized MAC addresses and motion data sharing. The client device 116 includes a hardware sensor 310 configured to generate sensor data 312 representing movement of the client device 116, one or more processors 302, and one or more computer-readable media storing computer-executable instructions that, when executed by the one or more processors 302, cause the client device 116 to perform the operations of the method 800.

At step 802, the client device 116 may detect, using the sensor data 312, movement of the client device 116. The sensor 310 continuously monitors the position and motion characteristics of the client device 116, generating sensor data 312 that indicates changes in location, orientation, acceleration, and velocity. The motion component 314 processes the sensor data 312 to determine whether the client device 116 is experiencing significant movement that warrants a handover prediction request. The client device 116 distinguishes between meaningful movement patterns, such as walking toward an exit or moving away from an access point coverage area, versus non-relevant movement such as stationary positioning or circular motion within the same coverage zone.

At step 804, the client device 116 may generate a handover prediction request including motion data representing the movement of the client device 116. The motion data included in the handover prediction request comprises location information, speed, and direction of movement of the client device 116. The location component 330 determines the current position of the client device 116 using the location system 318, which generates location data 320. The client device 116 controls the granularity of location information shared in the handover prediction request, providing precise coordinates, general location zones, or relative positioning information based on privacy preferences. The motion component 314 calculates speed and directional vectors from the sensor data 312, creating motion data 316 that represents the trajectory and velocity characteristics of the client device 116.

At step 806, the client device 116 may generate an anonymized media access control (MAC) address, wherein the client device 116 established a connection to a first access point of a first wireless network using a MAC address different than the anonymized MAC address. The privacy component 322 manages the generation and selection of anonymized MAC addresses 324 from a pool of randomized addresses received from the wireless network system 136. The anonymized MAC address differs from both the physical MAC address of the client device 116 and any MAC address used during the initial connection establishment with the first access point. The privacy component 322 ensures that each handover prediction request uses a unique, one-time anonymized MAC address that cannot be correlated to the device identity or previous network interactions.

Before transmitting the handover prediction request, the client device 116 may determine that a number of client devices connected to the first access point is greater than a threshold number such that anonymity of the client device 116 is maintained. The client device 116 monitors network activity levels to assess whether sufficient client device activity exists to preserve anonymity during the handover prediction query process. The client device 116 determines to transmit the handover prediction request based at least in part on the number of client devices connected to the first access point being greater than the threshold number. When few client devices are present on the network, the client device 116 may delay or skip the handover prediction request to avoid potential identification through process of elimination.

The client device 116 may receive a broadcast key or a multicast key that was distributed from the first wireless network. The encryption/authentication component 326 stores cryptographic keys 332 received from the wireless network system 136 during the authentication process. The client device 116 encrypts the handover prediction request using the broadcast key or the multicast key prior to transmitting the handover prediction request. The encryption ensures that only authenticated client devices connected to the wireless network can generate and process handover prediction requests, preventing unauthorized devices from accessing network topology information or generating malicious queries.

At step 808, the client device 116 may transmit the handover prediction request to the network using the anonymized MAC address to preserve device anonymity of the client device 116. The handover client 328 coordinates the transmission of the encrypted handover prediction request through the network interface 304. The use of the anonymized MAC address prevents the wireless network system 136 from correlating the handover prediction request to the specific client device 116 or linking the request to previous network interactions. The anonymized transmission enables the client device 116 to seek handover guidance without revealing device identity, location tracking history, or movement patterns that could compromise user privacy.

At step 810, the client device 116 may receive a handover prediction response indicating a time or a location at which the client device 116 is to handover to a second access point of a second wireless network. The handover prediction response provides proactive guidance regarding the timing, distance, or target access point for the anticipated handover event. The handover client 328 processes the handover prediction response to extract handover timing information, target network identification, and confidence levels associated with the prediction. The handover prediction response enables the client device 116 to prepare for the handover transition before signal quality degrades, reducing handover latency and improving user experience.

In response to detecting the time or the location indicated in the handover prediction response, the client device 116 may perform a handover to connect to the second access point of the second wireless network. The proactive nature of the handover prediction system enables the client device 116 to maintain a signal strength from the first access point that is above a threshold signal strength at the time or the location at which the client device 116 performed the handover to the second access point. The early handover initiation prevents service interruption and maintains connectivity quality during the transition between wireless networks, providing a superior user experience compared to reactive handover approaches that wait for signal degradation before initiating the handover process.

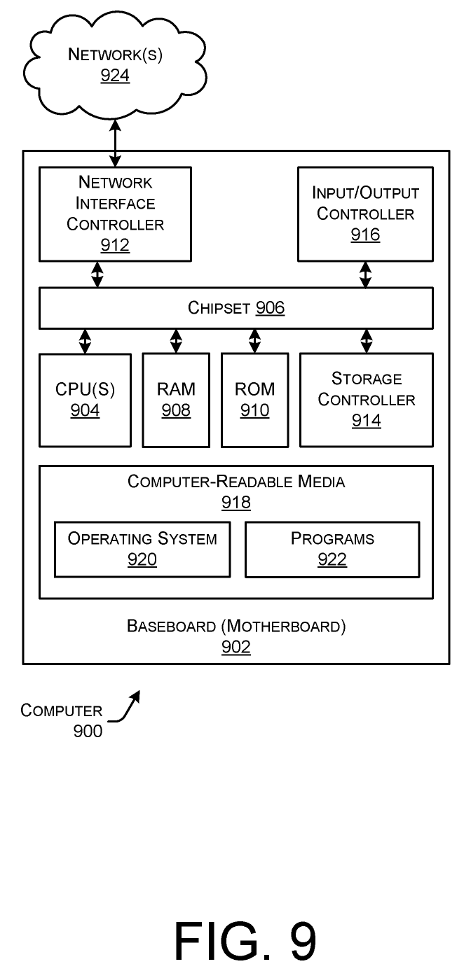

FIG. 9 shows an example computer architecture for a device capable of executing program components for implementing the functionality described above. The computer architecture shown in FIG. 9 illustrates any type of computer 900, such as a conventional server computer, workstation, desktop computer, laptop, tablet, network appliance, e-reader, smartphone, or other computing device, and can be utilized to execute any of the software components presented herein. The computer 900 may, in some examples, correspond to a client device 116, part of the wireless network system 136, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 900 includes a baseboard 902, or “motherboard,” which is a printed circuit board to which a multitude of components or devices can be connected by way of a system bus or other electrical communication paths. In one illustrative configuration, one or more central processing units (“CPUs”) 904 operate in conjunction with a chipset 906. The CPUs 904 can be standard programmable processors that perform arithmetic and logical operations necessary for the operation of the computer 900.

The CPUs 904 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 906 provides an interface between the CPUs 904 and the remainder of the components and devices on the baseboard 902. The chipset 906 can provide an interface to a RAM 908, used as the main memory in the computer 900. The chipset 906 can further provide an interface to a computer-readable storage medium such as a read-only memory (“ROM”) 910 or non-volatile RAM (“NVRAM”) for storing basic routines that help to startup the computer 900 and to transfer information between the various components and devices. The ROM 910 or NVRAM can also store other software components necessary for the operation of the computer 900 in accordance with the configurations described herein.

The computer 900 can operate in a networked environment using logical connections to remote computing devices and computer systems through a network, such as the network 924. The chipset 906 can include functionality for providing network connectivity through a NIC 912, such as a gigabit Ethernet adapter. The NIC 912 is capable of connecting the computer 900 to other computing devices over the network 924. It should be appreciated that multiple NICs 912 can be present in the computer 900, connecting the computer to other types of networks and remote computer systems.

The computer 900 can be connected to a storage device 918 that provides non-volatile storage for the computer. The storage device 918 can store an operating system 920, programs 922, and data, which have been described in greater detail herein. The storage device 918 can be connected to the computer 900 through a storage controller 914 connected to the chipset 906. The storage device 918 can consist of one or more physical storage units. The storage controller 914 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 900 can store data on the storage device 918 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 918 is characterized as primary or secondary storage, and the like.

For example, the computer 900 can store information to the storage device 918 by issuing instructions through the storage controller 914 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 900 can further read information from the storage device 918 by detecting the physical states or characteristics of one or more particular locations within the physical storage units.

In addition to the mass storage device 918 described above, the computer 900 can have access to other computer-readable storage media to store and retrieve information, such as program components, data structures, or other data. It should be appreciated by those skilled in the art that computer-readable storage media is any available media that provides for the non-transitory storage of data and that can be accessed by the computer 900. In some examples, the operations performed by the client device 116, the wireless network system 136, and or any components included therein, may be supported by one or more devices similar to computer 900. Stated otherwise, some or all of the operations performed by client device 116 and/or wireless network system 136, and or any components included therein, may be performed by one or more of the computers 900.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 918 can store an operating system 920 utilized to control the operation of the computer 900. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 918 can store other system or application programs and data utilized by the computer 900.

In one embodiment, the storage device 918 or other computer-readable storage media is encoded with computer-executable instructions which, when loaded into the computer 900, transform the computer from a general-purpose computing system into a special-purpose computer capable of implementing the embodiments described herein. These computer-executable instructions transform the computer 900 by specifying how the CPUs 904 transition between states, as described above. According to one embodiment, the computer 900 has access to computer-readable storage media storing computer-executable instructions which, when executed by the computer 900, perform the various processes described above with regard to FIGS. 1-8. The computer 900 can also include computer-readable storage media having instructions stored thereupon for performing any of the other computer-implemented operations described herein.

The computer 900 can also include one or more input/output controllers 916 for receiving and processing input from a number of input devices, such as a keyboard, a mouse, a touchpad, a touch screen, an electronic stylus, or other type of input device. Similarly, an input/output controller 916 can provide output to a display, such as a computer monitor, a flat-panel display, a digital projector, a printer, or other type of output device. It will be appreciated that the computer 900 might not include all of the components shown in FIGS. 3 and/or 4 , can include other components that are not explicitly shown in FIG. 9, or might utilize an architecture completely different than that shown in FIG. 9.

As described herein, the computer 900 may comprise one or more of a client device 116, a wireless network system 136, and/or any other device. The computer 900 may include one or more hardware processors (e.g., CPU(s) 904) configured to execute one or more stored instructions. The processor(s) may comprise one or more cores. Further, the computer 900 may include one or more network interfaces configured to provide communications between the computer 900 and other devices, such as the communications described herein as being performed by the client device 116 or wireless network system 136. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 922 may comprise any type of programs or processes to perform the techniques described in this disclosure for generating SNFs using a DSL and/or deploying SNFs to optimized network components.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for privacy-preserving handover prediction in a first wireless network, comprising:
receiving a handover prediction request from a client device connected to the first wireless network, the handover prediction request including motion data and being transmitted using a randomized Media Access Control (MAC) address that is different from a MAC address of the client device that was used to connect to the first wireless network;
determining, using the motion data, that the client device is moving away from a first access point of the first wireless network to a second access point of a second wireless network, the second wireless network being different than the first wireless network;
predicting, using the motion data, a time or a location at which the client device is to handover from the first access point to the second access point; and
transmitting a handover prediction response using the randomized MAC address to the client device, the handover prediction response indicating the time or the location at which the client device is to handover to the second access point.

2. The method of claim 1, wherein predicting the time or the location at which the client device is to handover from the first access point to the second access point includes:
determining that the client device will maintain signal strength from the first access point that is above a threshold signal strength at the time or the location at which the client device is to handover to the second access point.

3. The method of claim 1, further comprising:
storing a trained prediction model that is trained to predict times or locations at which client devices are to handover, the trained prediction model being trained on access point locations, historical motion data, and venue layout information,
wherein the time or the location is predicted at least partly using the trained prediction model.

4. The method of claim 1, further comprising:
generating a pool of randomized MAC addresses;
sending the pool of randomized MAC addresses to each of a plurality of authenticated client devices connected to the first wireless network; and
determining that the randomized MAC address used by the client device to transmit the handover prediction request is included in the pool of randomized MAC addresses,
wherein the handover prediction response is predicted in response to determining that the randomized MAC address is included in the pool of randomized MAC addresses.

5. The method of claim 4, further comprising periodically rotating and redistributing the pool of randomized MAC addresses to the authenticated client devices.

6. The method of claim 1, wherein the motion data included in the handover prediction request comprises location information, speed, and direction of movement of the client device.

7. The method of claim 1, further comprising:
distributing a broadcast key or a multicast key to authenticated client devices connected to the first access point,
wherein the handover prediction request is encrypted using the broadcast key or the multicast key.

8. The method of claim 1, wherein:
the first wireless network comprises a wireless local area network;
the second wireless network comprises a cellular network; and
the handover prediction response includes instructions for the client device to prepare to active a cellular link.

9. A wireless network system that provides privacy-preserving handover prediction in a first wireless network, the wireless network system comprising:
one or more processors; and
one or more non-transitory computer-readable media storing computer-executable instructions that, when executed by the one or more processors, cause the one or more processors to perform operations comprising:
receiving a handover prediction request from a client device connected to the first wireless network, the handover prediction request including motion data and being transmitted using a randomized Media Access Control (MAC) address that is different from a MAC address of the client device that was used to connect to the first wireless network;
determining, using the motion data, that the client device is moving away from a first access point of the first wireless network to a second access point of a second wireless network, the second wireless network being different than the first wireless network;
predicting, using the motion data, a time or a location at which the client device is to handover from the first access point to the second access point; and
transmitting a handover prediction response using the randomized MAC address to the client device, the handover prediction response indicating the time or the location at which the client device is to handover to the second access point.

10. The wireless network system of claim 9, wherein predicting the time or the location at which the client device is to handover from the first access point to the second access point includes:
determining that the client device will maintain signal strength from the first access point that is above a threshold signal strength at the time or the location at which the client device is to handover to the second access point.

11. The wireless network system of claim 9, the operations further comprising:
storing a trained prediction model that is trained to predict times or locations at which client devices are to handover, the trained prediction model being trained on access point locations, historical motion data, and venue layout information,
wherein the time or the location is predicted at least partly using the trained prediction model.

12. The wireless network system of claim 9, the operations further comprising:
generating a pool of randomized MAC addresses;
sending the pool of randomized MAC addresses to each of a plurality of authenticated client devices connected to the first wireless network; and
determining that the randomized MAC address used by the client device to transmit the handover prediction request is included in the pool of randomized MAC addresses,
wherein the handover prediction response is predicted in response to determining that the randomized MAC address is included in the pool of randomized MAC addresses.

13. The wireless network system of claim 12, the operations further comprising periodically rotating and redistributing the pool of randomized MAC addresses to the authenticated client devices.

14. The wireless network system of claim 9, wherein the motion data included in the handover prediction request comprises location information, speed, and direction of movement of the client device.

15. The wireless network system of claim 9, the operations further comprising:
distributing a broadcast key or a multicast key to authenticated client devices connected to the first access point,
wherein the handover prediction request is encrypted using the broadcast key or the multicast key.

16. A client device configured for anonymous handover prediction queries, comprising:
a hardware sensor configured to generate sensor data representing movement of the client device;
one or more processors; and
one or more computer-readable media storing computer-executable instructions that, when executed by the one or more processors, cause the client device to perform operations comprising:
detecting, using the sensor data, movement of the client device;
generating a handover prediction request including motion data representing the movement of the client device;
generating an anonymized media access control (MAC) address, wherein the client device established a connection to a first access point of a first wireless network using a MAC address different than the anonymized MAC address;
transmitting the handover prediction request to the network using the anonymized MAC address to preserve device anonymity of the client device; and
receiving a handover prediction response indicating a time or a location at which the client device is to handover to a second access point of a second wireless network.

17. The client device of claim 16, the operations further comprising:
determining that a number of client devices connected to the first access point is greater than a threshold number such that anonymity of the client device is maintained; and
determining to transmit the handover prediction request based at least in part on the number of client devices connected to the first access point being greater than the threshold number.

18. The client device of claim 16, the operations further comprising:
in response to detecting the time or the location, performing a handover to connect to the second access point of the second wireless network,
wherein the client device maintained a signal strength from the first access point that is above a threshold signal strength at the time or the location at which the client device performed the handover to the second access point.

19. The client device of claim 16, wherein the motion data included in the handover prediction request comprises location information, speed, and direction of movement of the client device.

20. The client device of claim 16, the operations further comprising:
receiving a broadcast key or a multicast key that was distributed from the first wireless network;
encrypting the handover prediction request using the broadcast key or the multicast key prior to transmitting the handover prediction request.
